(19) United States
(12) Patent Application Publication
(10) Pub. No.: US 2025/0146915 A1
(43) Pub. Date: May 8, 2025

(54) SYSTEM FOR CLAMPING AND ALIGNING A FLUIDIC CHIP TO A TISSUE SECTION

(71) Applicant: AtlasXomics Inc., New York, NY (US)

(72) Inventors: Zev KARTIGANER, Eaton, CT (US); Jeffrey MACDONALD, New York, NY (US); Gumaro ROJAS, New Haven, CT (US)

(21) Appl. No.: 18/736,248

(22) Filed: Jun. 6, 2024

Related U.S. Application Data
(60) Provisional application No. 63/471,399, filed on Jun. 6, 2023.

(51) Int. Cl. G01N 1/36; B01L 3/00

(52) U.S. Cl. CPC G01N 1/36; B01L 3/502715; B01L 2200/025

(57) ABSTRACT

The present disclosure generally relates to a clamping and aligning device for securely attaching a fluidic chip to a tissue sample. In some embodiments, the device includes a base member, a chip holder, a tissue aligner, and a clamping mechanism.

### CROSS-REFERENCE TO RELATED APPLICATIONS

This application claims priority to U.S. Provisional Patent Application No. 63/471,399, entitled “SYSTEM FOR CLAMPING AND ALIGNING A FLUIDIC CHIP TO A TISSUE SECTION,” filed on Jun. 6, 2023, the contents of which is hereby incorporated by reference in its entirety.

### FIELD

The present disclosure relates generally to tissue analysis systems and devices and, more specifically, to a system for clamping and aligning a fluidic chip to a tissue section.

### BACKGROUND

Microfluidic devices have been widely used in the field of biomedical research for various applications, such as drug discovery, cell culture, and tissue engineering. One important aspect of microfluidic devices is the ability to interface with biological samples, such as tissue sections, to perform various assays and analyses. However, the process of aligning and clamping a microfluidic chip to a tissue section can be challenging, especially when dealing with small and delicate samples. The clamping pressure required to isolate each microfluidic channel from one another while still enabling fluid flow becomes a delicate balance; generally the larger the pressure the stronger the seal between each channel, conversely the larger the pressure the more likely channels are to inhibit fluid flow. When reducing the size of the size the channels and the spacing between channels, the smaller the processing window becomes.

In summary, there is a need for a clamping and aligning system that can securely attach a microfluidic chip to a tissue section while maintaining the integrity of the sample and permitting controlled fluid flow.

### BRIEF SUMMARY

The present disclosure provides a clamping and aligning system for a microfluidic chip to a tissue section. The system comprises a base plate, a chip holder, a tissue aligner, and a clamping mechanism. The base plate is a rigid component that withstands the reaction force of the clamping mechanism. The chip holder is designed to securely hold the chip during alignment. The tissue aligner secures the substrate which the tissue section is secured and allows for planar movement of the tissue section. The clamping mechanism is designed to apply a controlled force to the microfluidic chip, which in turn presses against the tissue section to create a seal between the two surfaces. Prior to sealing the microfluidic chip against the tissue section, the chip must have a means of controlling its height; during alignment the chip must hover above the tissue, then lower onto the desired tissue region.

Many applications for microfluidic chips require the use of a microscope or other laboratory equipment. To ensure compatibility with a vast majority of this equipment, the clamping system was designed to fit within the planar footprint of a standard well plate while also minimizing the distance between the tissue section and the bottom of the base plate. This enhances the modularity of the system, since standard lenses can be used in laboratory microscopes for imaging. Overall, the system is designed to be compatible with various microfluidic chip designs, tissue section sizes and microscopes, and can be easily adjusted to accommodate different applications.

In accordance with some embodiments, a clamping and aligning device for securely attaching a fluidic chip to a tissue sample is described. The device includes a base member; a chip holder, configured to receive a microfluidic chip and to allow the microfluidic chip to contact a tissue sample of interest; a tissue aligner configured to align a substrate to which the tissue sample of interest is attached along at least one alignment axis; a clamping mechanism configured to apply a variable amount of clamping force to the fluidic chip to clamp the fluidic chip to the tissue sample of interest when the fluidic chip and the tissue sample of interest are mounted in the clamping and aligning device, wherein: the clamping and aligning device defines a light-transmitting path from a first side of the clamping and aligning device to a second side of the clamping and aligning device, and the light-transmitting path passes through a first optical opening in the base member, a second optical opening in the clamping mechanism, and the tissue sample of interest, when the tissue sample of interest is mounted in the clamping and aligning device.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1 is an illustration of a clamping and aligning system, in accordance with some embodiments.

FIG. 2 is an illustration of a force controlling system of a clamping and aligning system, in accordance with some embodiments.

FIG. 3 is an illustration of a mechanism for setting and selecting the force for the compression mechanism of a clamping and aligning system, in accordance with some embodiments.

FIG. 4 is an illustration of a planar alignment system of a clamping and aligning system, in accordance with some embodiments.

FIG. 5 is an illustration of a planar alignment system of a clamping and aligning system, in accordance with some embodiments.

FIG. 6 is an illustration of a clamping and aligning system in an open, chip loading position, in accordance with some embodiments.

FIG. is an illustration of a compression head selector system of a clamping and aligning system, in accordance with some embodiments.

FIG. 8 is a sectional side view of a clamping and aligning system, illustrating thicknesses of various components (in millimeters), in accordance with some embodiments.

FIG. 9 is a sectional perspective view of a clamping and aligning system, illustrating thicknesses of various components (in millimeters), in accordance with some embodiments.

FIG. 10 is a sectional perspective view of a clamping and aligning system with illustrations of a working distance, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for a clamping and aligning system that can securely attach a fluidic chip to a tissue section while maintaining the integrity of the sample and permitting controlled fluid flow. The clamping and alignment systems described herein address that need.

The present disclosure provides a clamping and aligning system for a fluidic chip to a tissue section. The system comprises a base plate, chip holder, a tissue aligner, and a clamping mechanism.

The base plate is a flat surface made of a strong ridged material, such as glass, plastic, or metal, which sandwiches the tissue section with the compression head on the opposing side. The compression head, another component of the compression mechanism, contacts the microfluidic chip and presses the chip into the tissue followed by the tissue substrate to the base plate which counteracts the force, maintaining the static system.

The microfluidic chip is loaded into/onto the chip holder where its position is controlled. Similarly, the tissue section aboard its substrate is loaded in the tissue aligner where its position is controlled.

The clamping mechanism is designed to apply a known and controlled force to the microfluidic chip, which in turn presses against the tissue section to create a seal between the two surfaces. In some embodiments, the force is from 0.5 to 100 pounds per square inch (PSI). In some embodiments, the force is from 4 to 40 PSI, 10 to 30 PSI, or 15 to 25 PSI.

The clamping mechanism can be of various designs, such as a screw-type mechanism, a spring-loaded mechanism, an electronically controlled system or a pneumatic system. The clamping mechanism can be integrated within the microfluidic chip where the chip itself acts as the regulator. The clamping mechanism can also be a separate component that can be easily attached and detached to the clamp or chip.

To limit the startup cost for new users, the following designs focused on allowing new users to use existing equipment within their lab such as a microscope. Therefore, the designs conceptualized focused on self-contained systems with viewing windows through the clamping target.

Most microscope objectives have relatively small working distances. Therefore, it can be beneficial to reduce the thickness of the base plate. While it is theoretically possible to make the base plate infinitely thin, doing so can affect the clamping mechanism's ability to provide larger loads with minimal plate deflection. Plate deflection can cause the substrate with the tissue, generally glass, to break. The following design utilizes a 2.5 mm thick base plate made from aluminum to balance the weight limitations of a microscope stage along with stiffness of the plate under clamping loads and the working distance required to focus the microscope on the tissue section. In addition to increased compatibility with microscopes with small working distances, this combination is quite compatible with other microscopes when utilizing a long-distance working objective.

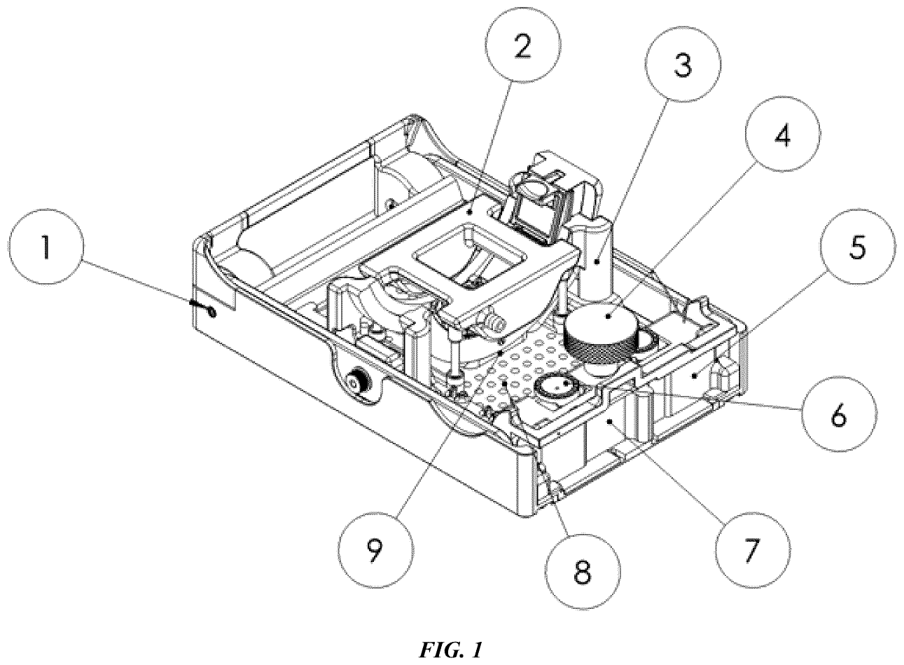

FIG. 1 shows “Design 1.” In this design all the systems are all onboard the assembly. The compression head, balloon 9, is attached to the link arms by the carriage shown by balloon 3 which are connected to the base plate via the rotation axis identified by balloon 1 and the compression mechanism cover shown in balloon 5. The fluidic chip depicted by balloon 8 can be exposed by an unlatching lever on the compression mechanism. The height of the chip can be controlled by the force driving mechanism, a screw, shown in balloon 4. The compression system bottoms out on the pressure selector shown in balloon 7. This selector has multiple preset screw displacement settings that can be selected prior to clamping. This allows multiple chip types and configurations to be used within the same clamp. Prior to the chip touching down on the tissue section, the target can be located using the tissue aligner displayed in balloon 6.

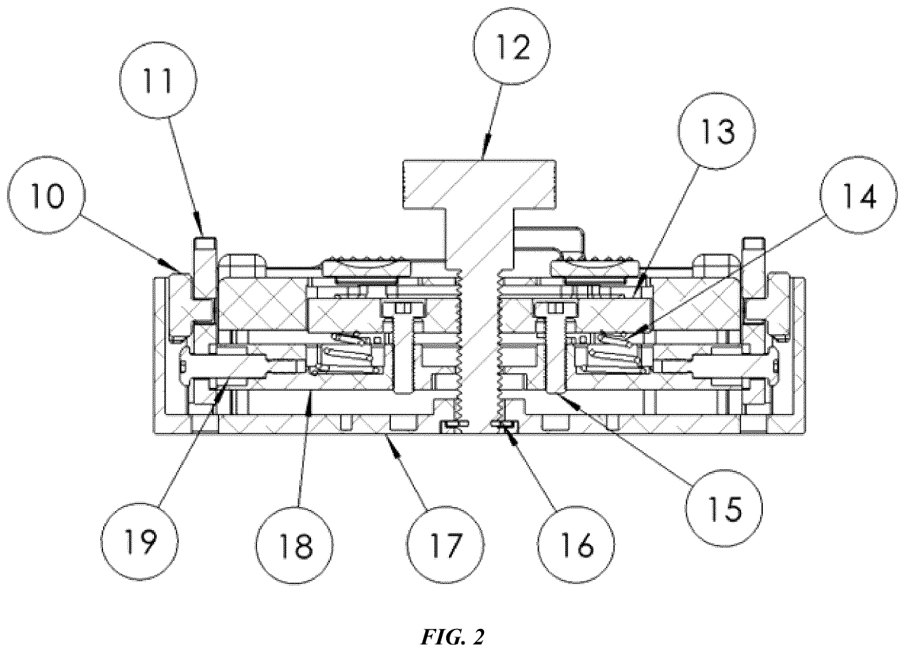

FIG. 2 isolates the force controlling system of the compression mechanism in “Design 1.” Balloon 10 identifies one of the link arms that are connected to the compression head and directs force to the fluidic chip. The link arm is connected to the compression mechanism the latch identified by balloon 11. The force from the latch is carried through shoulder screw shown by balloon 19 to the bottom compression plate depicted by balloon 18. The force on the bottom compression plate is controlled by the springs identified by balloon 14. The springs are sandwiched between the bottom compression plate and the top compression plate identified in balloon 13. When the reaction force from the chip is less than the spring load, such as when the chip is being aligned the spring force is counteracted by the screw depicted in balloon 15. This screw allows the link arms to also control angular position, and thus height of the chip relative to the tissue section when the pre-compressed spring force is greater than the load applied to the chip. The displacement between chip and the tissue is controlled via the threaded hole in the top compression plate and the controlling screw identified in balloon 12. Therefore, the controlling screw also is the driving mechanism that forces the chip into the tissue. The driving screw is connected to the base plate via a clip shown in balloon 16. This clip allows the top and bottom compression plates to move closer and further away from the base plate without the screw itself moving into or out of the base plate. The clip is secured to the base plate by a cover.

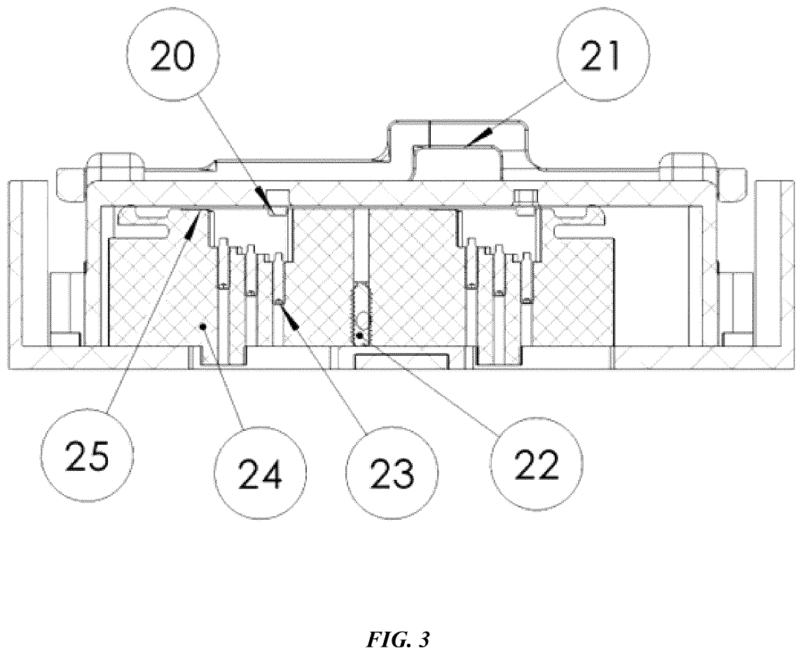

FIG. 3 displays the mechanism for setting and selecting the force for the compression mechanism of “Design 1.” The parts identified by balloon 20 are the hard-stop features of the top compression plate. The controlling screw drives this component up and down. The lower position limit is set by the selector switch identified in balloon 24. The selector switch can be manipulated and set to a known location by sliding the switch to the left or right. The location of the selector switch can be identified by a series of detents and a spring plunger identified in balloon 22. In this design there are 4 settings that the selector switch can be tailored to: 3 force settings controlled by the set screws in balloon 23 and an alignment and ejection location shown to the left of the set screws in balloon 25. Only when the selector switch is set to the ejection location can the latch, identified in balloon 21, be opened. To move the selector switch into the ejection and alignment location, the top compression plate must be manipulated to a position where there is clearance between the ledge identified by balloon 25 and the hard stops of the top compression plate identified by balloon 20. This ensures that users do not accidentally touch the chip down onto the biological section prior to aligning the microfluidic chip.

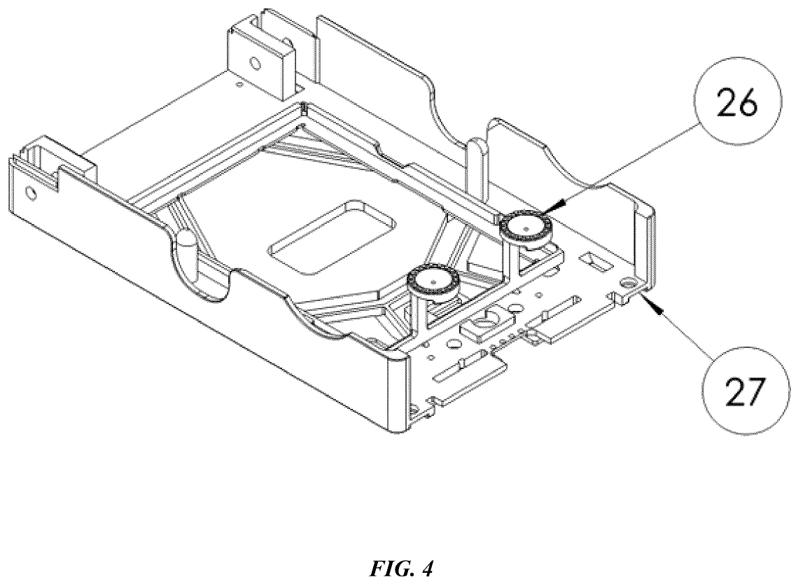

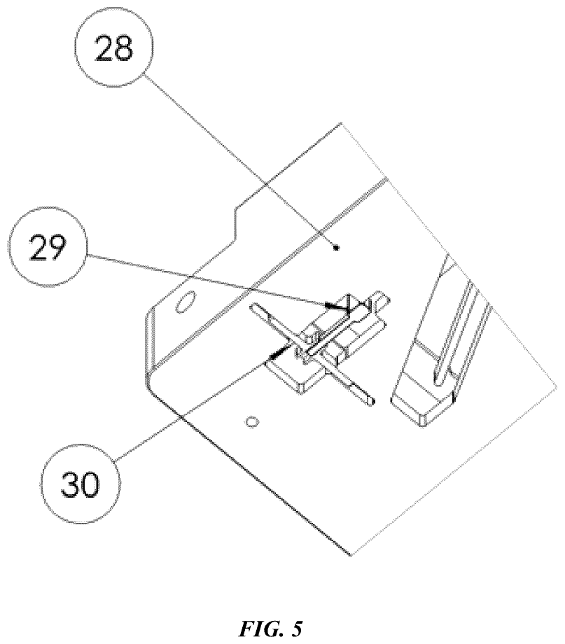

FIG. 4 and FIG. 5 displays the planar alignment system of “Design 1.” The aligner, shown by balloon 26 can control the tissue section's location by pushing the sides of the substrate that the biological specimen is attached to. The aligner rests on top of the base plate shown in balloon 27 and can be manipulated by the access area displayed by balloon 26. The aligner is locked into the base plate from the bottom, shown in FIG. 5. The aligner has columns on the bottom side shown by balloon 29 which is free-moving in a single direction by a slot in the aligner tee displayed in balloon 30. The aligner tee is free-moving in a different, singular direction controlled by another slot in the base plate.

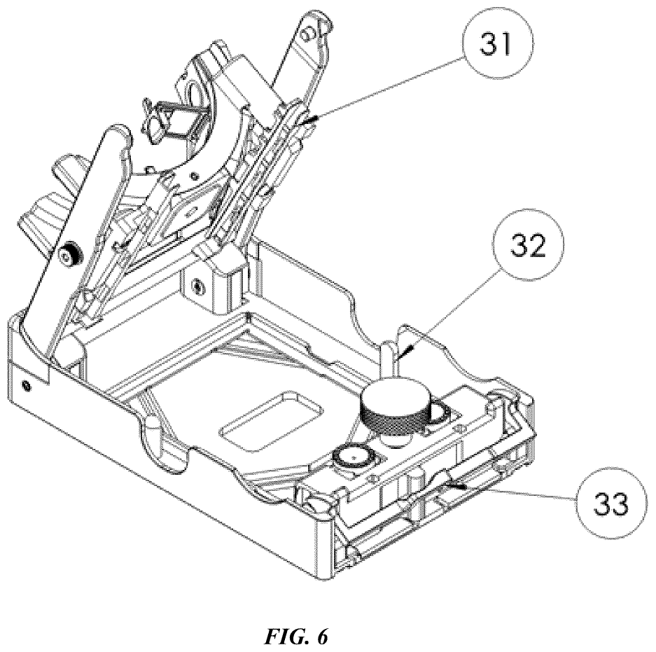

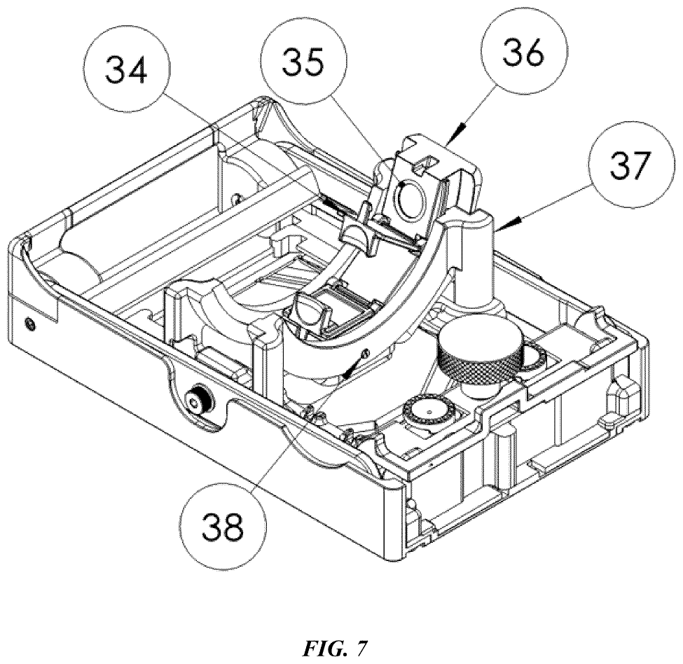

FIG. 6 displays “Design 1” in the open, chip loading position. To open the system, the latch needs to be pulled back as displayed by balloon 33. The fluidic chip(s) can be placed in two opposing slots shown by balloon 31. The pins identified by balloon 32 are used to align and direct the fluidic chip over the biological sample.

FIG. 7 displays the compression head selector system of “Design 1.” The compression head is shown by balloon 36. This compression head has three different modes of operation: furthest left center and right. The compression head can rotate along the carriage identified by balloon 37 and stop at the preferred mode with a detent detecting ball plunger shown by balloon 38. The two outer positions, left and right, have openings for reaching a fluidic chip chamber. These openings can be sealed shut by a clasp and gasket displayed by balloons 34 and 35 respectively.

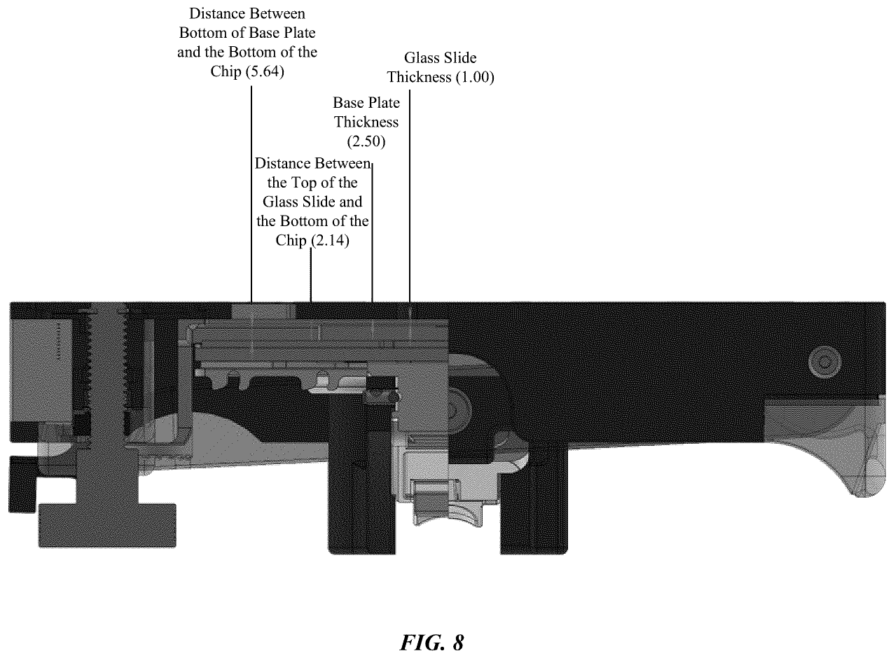

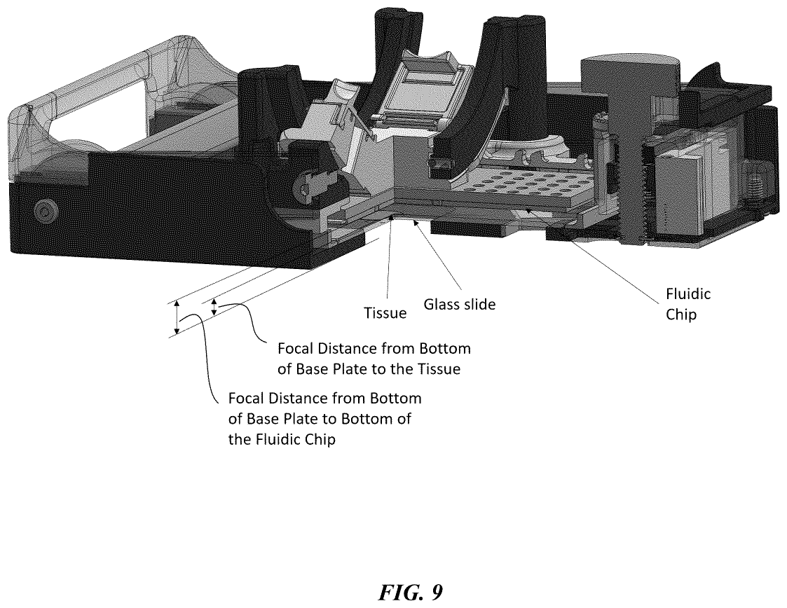

Most microscope objectives have relatively small working distances. Therefore, it is beneficial to reduce the thickness of the base plate. The base plate can be made infinitely thin, however that impacts the clamping mechanism's ability to provide larger loads with minimal plate deflection. Plate deflection can cause the substrate with the tissue, generally glass, to break. The design illustrated herein (e.g., in FIGS. 8, 9, and 10) utilizes a 2.5 mm thick base plate made from Aluminum to balance the weight limitations of microscope stage along with stiffness of the plate under clamping loads and the working distance required to focus the microscope on the tissue section. This combination is highly compatible with other microscopes when utilizing a long-distance working objective.

To enable alignment of the chip relative to the tissue/tissue substrate, the systems described herein maintain a gap present between the fluidic chip bottom and the tissue section when the clamp is engaged in the alignment/ejection position.

Having the ability to continuously reduce the clearance between the fluidic chip's bottom face and the top face of the tissue is highly preferred, so as to bring both the chip's bottom and the tissue section into view on a single focal plane. This allows alignment of the fluidic chip to the tissue section to become more streamlined, effective, and accurate. This is a preferred embodiment because microscope objectives generally have a very thin focal plane. Images outside of the focal plane become blurry (even invisible) very quickly. Being able to lower the chip near the tissue in a controlled and continuous manner allows the user to bring both the tissue and the chip into view during the alignment step (e.g., based on the pitch of the screw and the mechanical advantage we can adjust this distance approximately 500 μm per 360-degree turn of the control screw/knob).

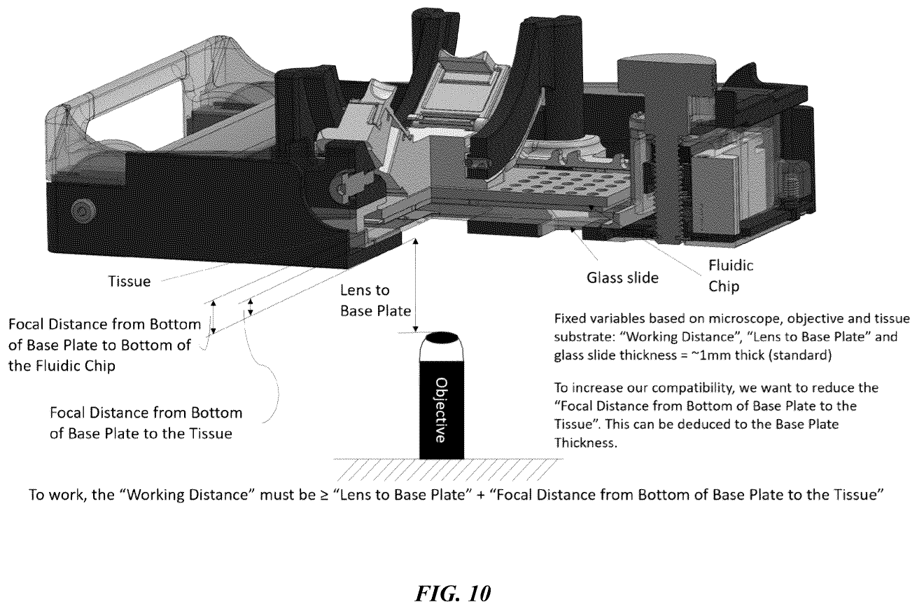

In some embodiments (e.g., as shown in FIG. 10), a light-transmitting path from a first side of the clamping and aligning device to a second side of the clamping and aligning device is formed through the clamping and aligning system. The light-transmitting path passes through a first opening in the base member, a second opening in the clamping mechanism, and the tissue sample of interest, when the tissue sample of interest is mounted in the clamping and aligning device. In some embodiments, a distance, along the light-transmitting path, between a distal edge of the tissue sample of interest and an exterior surface of the base member, when the microfluidic chip and the tissue sample of interest are mounted in the clamping and aligning device, is no greater than 5 mm. In some embodiments, it is no greater than 4 mm. In some embodiments, it is no greater than 3 mm, 2 mm, or 1 mm.

The processing steps to use this device are as follows. Set the selector switch of the device to the ejection and alignment position. Next, the user would open the clamp and load the tissue attached to the tissue's substrate (typically a glass slide) into the aligner on top of the base plate. The user would then insert the fluidic chip into the chip holder and close the device. At this point the fluidic chip is hovering on top of the tissue section and its substrate. The user would adjust the device's selector switch to the proper, preconfigured clamping load appropriate for their given chip, and load the assembly (device, chip and tissue) into their microscope, focusing the lens on the tissue section. The user now can lower the fluidic chip into view with the tissue without the chip touching the tissue. When the chip comes into view, the user would then align the tissue's targeted region of interest with the corresponding location of the fluidic chip. Now the user would clamp the fluidic chip to the tissue at their desired clamping force by turning the control knob. When the control knob provides apparent resistance (a hard stop), the user knows that the appropriate force/sealing pressure has been met. The user would then load and flow the chip as required by the assay and remove the assembly from the microscope. Finally, the user would finish their application by unscrewing the control knob as far as it will go (another hard stop), setting the selector switch on the device to the ejection position, opening the device and removing their chip and tissue.

What is claimed is:

1. A clamping and aligning device for securely attaching a fluidic chip to a tissue sample, the device comprising:
a base member;
a chip holder, configured to receive a fluidic chip and to allow the fluidic chip to contact a tissue sample of interest;
a tissue aligner configured to align a substrate to which the tissue sample of interest is attached along at least one alignment axis;
a clamping mechanism configured to apply a variable amount of clamping force to the fluidic chip to clamp the fluidic chip to the tissue sample of interest, when the fluidic chip and the tissue sample of interest are mounted in the clamping and aligning device, wherein:
the clamping and aligning device defines a light-transmitting path from a first side of the clamping and aligning device to a second side of the clamping and aligning device, and
the light-transmitting path passes through a first opening in the base member, a second opening in the clamping mechanism, and the tissue sample of interest, when the tissue sample of interest is mounted in the clamping and aligning device.

2. The clamping and aligning device of claim 1, wherein a distance, along the light-transmitting path, between a distal edge of the tissue sample of interest and an exterior surface of the base member, when the fluidic chip and the tissue sample of interest are mounted in the clamping and aligning device, is no greater than 4 mm.

3. The clamping and aligning device of claim 1, wherein the variable amount of clamping pressure with the area defined by the clamping face is 0.5 to 100 PSI.

4. The clamping and aligning device of claim 1, wherein the variable amount of clamping force is set by limiting the displacement of a screw or screw driven mechanism.

5. The clamping and aligning device of claim 1, wherein the clamping mechanism includes:
a compression mechanism configured to contact the fluidic chip and to apply the clamping force to the fluidic chip; and
a clamping force adjustment mechanism configured to change the variable amount of clamping force by displacing the compression mechanism along an axis parallel to the light-transmitting path.

6. The clamping and aligning device of claim 1, wherein the chip holder includes a fluid and vapor retaining mechanism that includes a clasp/snap and a gasket.

7. The clamping and aligning device of claim 1, wherein the clamping mechanism is rotatably attached to the base plate via an attachment member configured to allow the clamping mechanism to rotate at least partially around an axis that is perpendicular to the light-transmitting path.

8. The clamping and aligning device of claim 1, further comprising a set of one or more alignment pins configured to:
direct the variable clamping force along an axis perpendicular to a primary plane of the fluidic chip, when the fluidic chip and the tissue sample of interest are mounted in the clamping and aligning device, and
position the fluidic chip parallel to the substrate to which the tissue sample of interest is attached, when the fluidic chip and the tissue sample of interest are mounted in the clamping and aligning device.
